(19) United States
(12) Patent Application Publication
(10) Pub. No.: US 2008/0259757 A1
(43) Pub. Date: Oct. 23, 2008

(54) Method of Adjusting Writing Parameters, Optical Disc Writer and Method of Recording Data Using the Same

(75) Inventors: Jing Tao, Shanghai (CN); Jianyi Zhong, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,458

(22) PCT Filed: Nov. 1, 2006
(86) PCT No.: PCT/IB2006/054036

§ 371 Date: May 2, 2008

(30) Foreign Application Priority Data
Nov. 3, 2005 (CN) 200510120086.2

(51) Int. Cl. G11B 5/00

(52) U.S. Cl. 369/47.53

(57) ABSTRACT

The present invention discloses a method of adjusting writing parameters, comprising the steps of testing a region to be written in a re-writeable optical disc without changing writing power level; calculating writing parameters in the region to be written based on the tested result; and adjusting writing parameters based on the calculated result. According to embodiments of the present invention, the direct over writing compatibility problem can be resolved. Moreover, power level adjusting is kept unchanged so as to avoid possible damage to direct over writing cycleability.

### FIELD OF THE INVENTION

The present invention relates to a method of optimizing writing strategy for re-writeable optical discs, and particularly to a method of optimizing writing strategy to adapt to the different direct over writing (DOW) histories and an optical disc writer and method of recording data on the optical discs using such method.

### BACKGROUND OF THE INVENTION

At present, the optical system has become an ideal carrier for a mass of data owing to its relatively low cost and large capacity. The current optical discs include: CD (compact disc) using the EFM (Eight to Fourteen Modulation) encoding rule; DVD using the EFM+encoding rule; BD (Blue-ray Disc) using the 17PP encoding rule and some other unpopular optical discs. Each of the above kinds of optical disc also could be classified into a read-only optical disc, a recordable optical disc or a re-writeable optical disc.

As for the re-writeable optical disc, data is represented by marks written by a recording laser and spaces between the marks. Since the marks and spaces have a different reflectance to the focused reading laser, high-frequency modulated signals are generated. Analog high-frequency signals are sent to a binary signal slicer after AC coupling and compared with the slice level to convert into a binary data; thus, a mark level and a space level corresponding to the marks and spaces on the optical disc respectively are obtained. Then, after being coupled to a clock signal, the runlength of each mark and space could be obtained so as to restore the recorded original data.

The restoration of the original data depends on the mark runlength and space runlength obtained by slicing, but it is ultimately determined by the physical runlength of the marks by writing. The physical length of spaces are decided by the physical lengths of the two marks adjacent thereto, so the accuracy of the written physical runlength of the marks decides the deviation amount of the read runlength of the marks and spaces, thereby deciding the quality of the writing of an optical disc.

The physical lengths of the marks and spaces are determined by the writing parameters. In order to write an optical disc accurately, many different writing strategies containing various writing parameters have been developed according to types of optical discs. Moreover, some methods which are adapted to optimizing the writing strategy dynamically during writing in different drivers are emerging. However, for re-writeable discs writing, there exists a famous DOW problem. DOW history is always random from region to region throughout a re-writeable disc. For example, DOW history is zero (virginal blank) in one region, but DOW history is 300 in another region. Generally, the physical properties of re-writeable media are different with different DOW histories. Thus, the optimized/calibrated writing strategy done in the optimum power control (OPC) area before writing is not really optimum for the data area with different DOW histories. Normally, this is called the “DOW compatibility” problem.

Current methods for optimizing the writing strategy dynamically do not work well for the DOW problem. For example, the Walking-OPC method is only applicable to re-writeable discs like DVD+R where only write power is calibrated according to Beta measurement. The Walking-OPC method is based on real-time reflection signals from the disc during recording to overcome reflection variation and defects like a fingerprint, but it is not stable and increased power will deteriorate the DOW cycleability.

In summary, the conventional methods for optimization the writing strategy have no capability of solving the DOW problem.

### OBJECT AND SUMMARY OF THE INVENTION

It is an object of the invention to propose a method of optimizing writing strategy to adapt to the different DOW histories during writing.

The technical problem to be solved by the present invention is to provide a method of optimizing writing strategy to adapt to different DOW histories and an optical disc writer and method of writing data on the optical discs using such method.

According to an embodiment of the present invention, a method of adjusting writing parameters, comprises the steps of testing a region to be written in a re-writeable disc without changing writing power level; calculating writing parameters in the region to be written based on the tested result; and adjusting writing parameters based on the calculated result.

According to another embodiment of the present invention, an optical disc writer comprises a reading and writing device for reading or writing data on an optical disc; a measurement device coupled to the reading and writing device for measuring and determining signal quality of a written region; a calculation device coupled to the reading and writing device and the measurement device for calculating writing parameters in a region to be written based on tested result made in the region to be written without changing writing power level; and an adjustment device coupled to the reading and writing device for adjusting writing parameters based on the calculated result.

According to another embodiment of the present invention, a method of writing data on a re-writeable disc comprises the steps of writing data on the re-writeable disc; stopping to write data and determining signal quality of the written data; testing a region to be written in a re-writeable disc without changing writing power level; calculating writing parameters in the region to be written based on the tested result; adjusting writing parameters based on the calculated result; and continuing to write data on the re-writeable disc

The embodiments of the present invention resolve the DOW compatibility problem. Moreover, according to an embodiment of the present invention, power adjustment is kept unchanged so as to not deteriorate the DOW cycleability.

The other objects and achievements of the present invention will be apparent from the description of the present invention with reference to the following drawings and claims, to allow one to have a thorough understanding of the present invention.

### BRIEF DESCRIPTION OF THE DRAWINGS

FIG. 1 is a schematic flowchart of a method of optimizing writing strategy adapted to different DOW histories according to an embodiment of the present invention,

FIG. 2 is a schematic flowchart of a method of obtaining the modulation amounts of the writing parameters according to an embodiment of the present invention,

FIGS. 3, 4 and 5 are experiments and measurements made for determining the gains according to an embodiment of the present invention,

FIG. 6 is a schematic block diagram illustrating an optical disc writer according to an embodiment of the present invention,

FIGS. 7, 8 and 9 show the results of experiments under different conditions after optimization of the runlength deviation of 3T, 4T and 5T marks, in which the optimizing target is the standard length of each mark as specified by the standard.

In the above drawings, the same reference symbol indicates the same, similar or corresponding characteristics or functions.

### DETAILED DESCRIPTION OF THE INVENTION

The present invention is directed to providing a dynamic writing strategy optimization algorithm to solve the DOW compatibility problem during writing re-writeable discs without deteriorating the DOW cycleability.

The method of adjusting writing parameters of an embodiment of the present invention is described as follows. At first, a region to be written in a re-writeable disc is tested without changing writing power level, then the writing parameters in the region to be written based on the tested result is calculated. Finally, the writing parameters based on the calculated result are adjusted. Consequently, multiple writing parameters are adjusted simultaneously based on the calculated result, the DOW compatibility problem is resolved and the DOW cycleability is not deteriorated because the writing power level is kept unchanged. In addition, the total jitter is minimized.

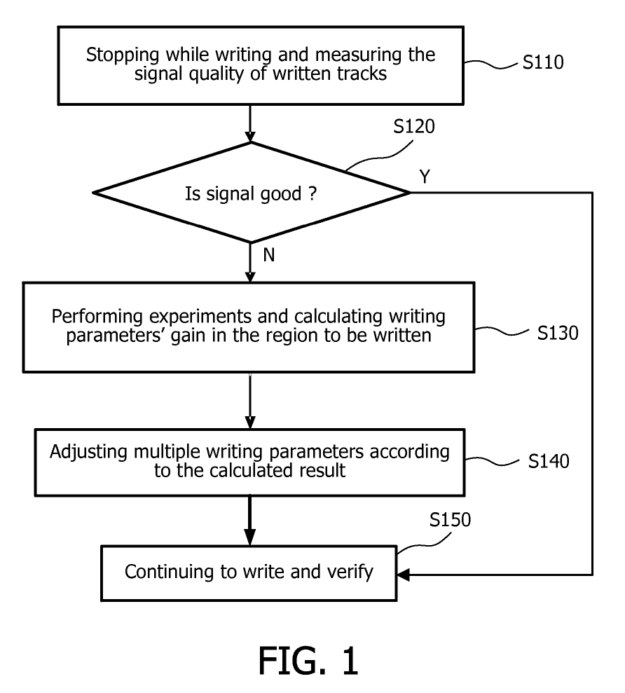

FIG. 1 is a schematic flowchart illustrating a method of optimizing writing strategy adapted to different DOW histories according to an embodiment of the present invention. In step S110, the operations of writing data on a re-writeable disc are stopped. The optical disc writer does not write any more data on the disc until the optical disc writer is instructed to restart the writing operations. The quality of the signal written on the disc shortly before stopping is measured. For example, some parameters like jitter, which is the standard deviation of the timing difference between the sliced data edge and the clock edge; C1, which is the output of the first level (PI) of Error Correction Decoding, and C2, which is the output of the second level (PO) of Error Correction Decoding of the written tracks are measured to determine the quality of the signal. The exact explanations of the meaning of the above parameters may be referred to the standard books of relevant optical discs and are not explained in detail.

Next, in step S120, the optical disc writer determines whether the quality of the signal is good or not. There are many criteria that can be used for the above determination. Normally, a loose criterion may be set when the optical disc writer is recording AV (audio/video) data to a re-writeable disc and a tight criterion may be set when non-AV data are recorded. That is, the acceptable quality is decided by the system designer. For example, the criterion of jitter<10%, C1<100 and C2<0 can be employed in this step.

If the quality of signal is good, the optical disc writer proceeds to step S150. If the quality is poor and the writing parameters should be adjusted, the optical disc writer proceeds to step S130.

In step S130, the optical disc writer does some experiments or tests on the current area to be written on the disc without changing the writing power level to test the physical properties of the area. Due to different DOW histories, the writing parameters for one region may not be appropriate for another region. The experiments or tests are carried out for each writing parameter. In an embodiment of the present invention, the writing parameters are timing parameters. According to the results of the experiments or tests, the writing parameters (such as modulation amount of each parameter) in the region to be written are calculated. In an embodiment of the present invention, the calculated result is calculated by a desired mark runlength variation and writing parameters' gain. In another embodiment of the present invention, the results of the experiments or tests are physical properties of the re-writable disc with different DOW histories. The aim of optimizing writing strategy is to make the mark runlength of each symbol close to the precise mark runlength (e.g., the standard mark runlength specified by the optical disc standard). By standardizing the runlength of each mark, the space runlength will also be standardized so as to obtain smaller length jitter or position jitter of marks and spaces. Therefore, the target of mark runlength adjustment is normally zero for every symbol, thereby minimizing the total jitter. From this target, the desired mark runlength variation can be determined.

In step S140, on the basis of the calculated result, the optical disc writer adjusts the multiple writing parameters simultaneously to accomplish the optimization of the writing strategy. Afterwards, step S140 also may include a step that re-performs the writing tests to determine whether the quality of the signal is acceptable. If the quality is still unacceptable, the above optimization steps may be repeated.

After optimization (steps S130 and S140), in step S150, the optical disc writer continues writing data on the disc and then verifies the data as usual.

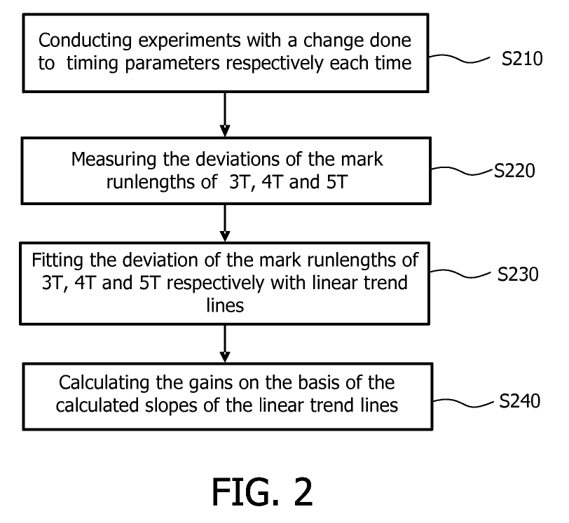

Referring to FIG. 2, it illustrates a method of obtaining the modulation amounts of the writing parameters according to an embodiment of the present invention. In this embodiment, the gains K3, K4 and K5 will be calculated respectively to determine the change rates of the timing parameters for writing marks of 3T, 4T and 5T. With desired mark runlength variation, the modulation amounts of the timing parameters can be produced as:

dT_{M}=dR_{M}/K_{M}; M=3, 4 or 5;
wherein,
   dTM is the modulation amount of the timing parameter,
   dR_{M} is desired mark runlength variation and K_{M} is the gain.

As known, the physical runlengths of marks depend on either the power parameters or timing parameters. In this embodiment, the timing parameters are modulated and the power parameters are kept unchanged.

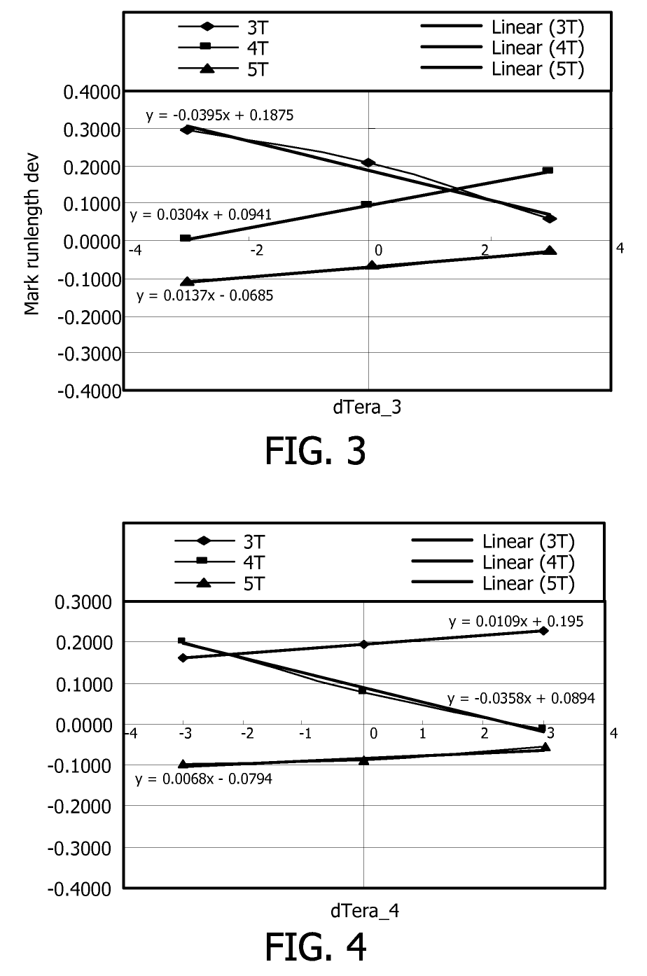

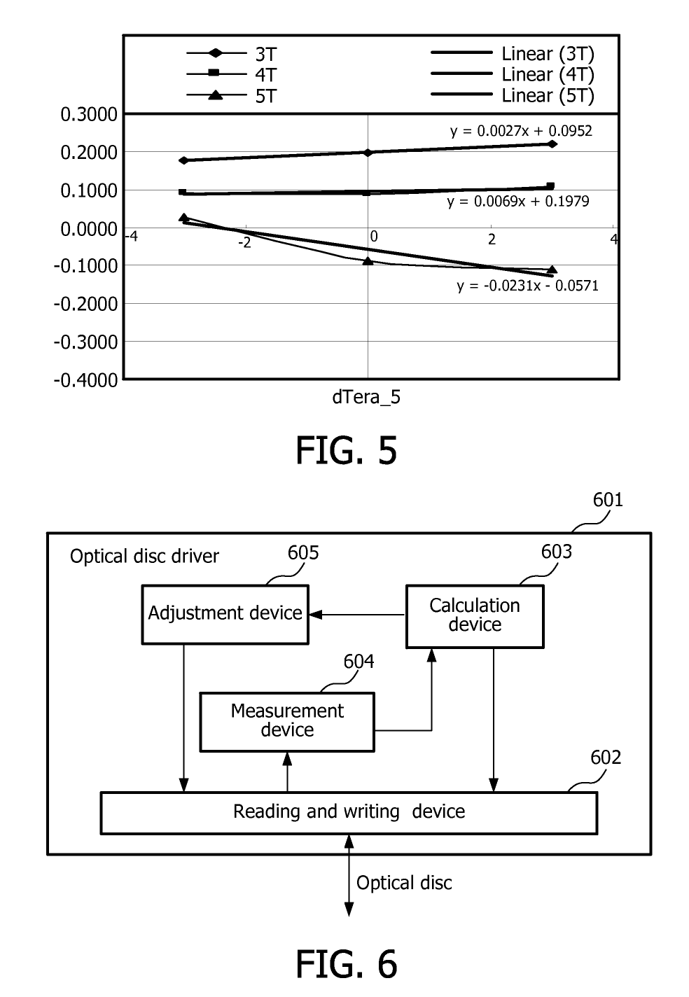

In Step S210, a series of writing experiments are conducted according to the present value of these timing parameters with a change made to these timing parameters respectively each time. And then, in step S220, the deviations of the mark runlengths of the 3T, 4T and 5T are measured. Subsequently, in step S230, the obtained measured results (as shown in FIGS. 3, 4 and 5) are fitted with their linear trend lines. In step S240, on the basis of the calculated slopes of the linear trend lines, the gains can be calculated as follows:

K3=−0.0395−(0.0304+0.0137)/2=−0.0615

K4=−0.0358−(0.0109+0.0068)/2=−0.0447

K5=−0.0231−(0.0068+0.0027)/2=−0.027

After obtaining the gains, the modulation amounts are determined. The writing parameters are then changed according to the modulation amounts so that the writing strategy is optimized by using the above method.

According to the above embodiment, the DOW compatibility problem is resolved and the DOW cycleability is not deteriorated because the writing power level is kept unchanged.

FIG. 6 is a schematic block diagram illustrating an optical disc writer 601 according to an embodiment of the present invention. The optical disc writer 601 comprises a reading and writing device 602 for reading or writing data on an optical disc; a measurement device 604 coupled to the reading and writing device 602 for measuring and determining signal quality of a written region; a calculation device 603 coupled to the reading and writing device 602 and the measurement device 604 for calculating writing parameters in a region to be written based on tested result made in the region to be written without changing writing power level; and an adjustment device 605 coupled to the reading and writing device 602 for adjusting writing parameters based on the calculated result. At the beginning of the writing process, the measurement device 604 measures the quality of the signal just recorded, such as measuring the parameters jitter, C1 and C2, and transmits the results to the calculation device 603 to determine whether the quality of signal is good or not. If the quality is acceptable and the writing strategy does not need to be optimized, the optical disc writer 601 restarts the writing process to write data on the disc.

If the quality is not good, the calculation device 603 sends a series of instructions to the reading and writing device 602. According to the instructions, the reading and writing device 602 conducts a series of writing experiments without changing the writing power level. The measurement device 604 measures the runlengths of these marks written in the experiments and transmits the results to the calculation device 603. The calculation device 603 calculates the writing parameters' gains and determines the modulation amount of each writing parameter with the desired mark runlengths. And then, the calculation device 603 sends these modulation amounts to the adjustment device 605. The adjustment device 605 changes the writing parameters according to these modulation amounts and transmits the changed writing parameters to the reading and writing device 602 for use in the subsequent writing process.

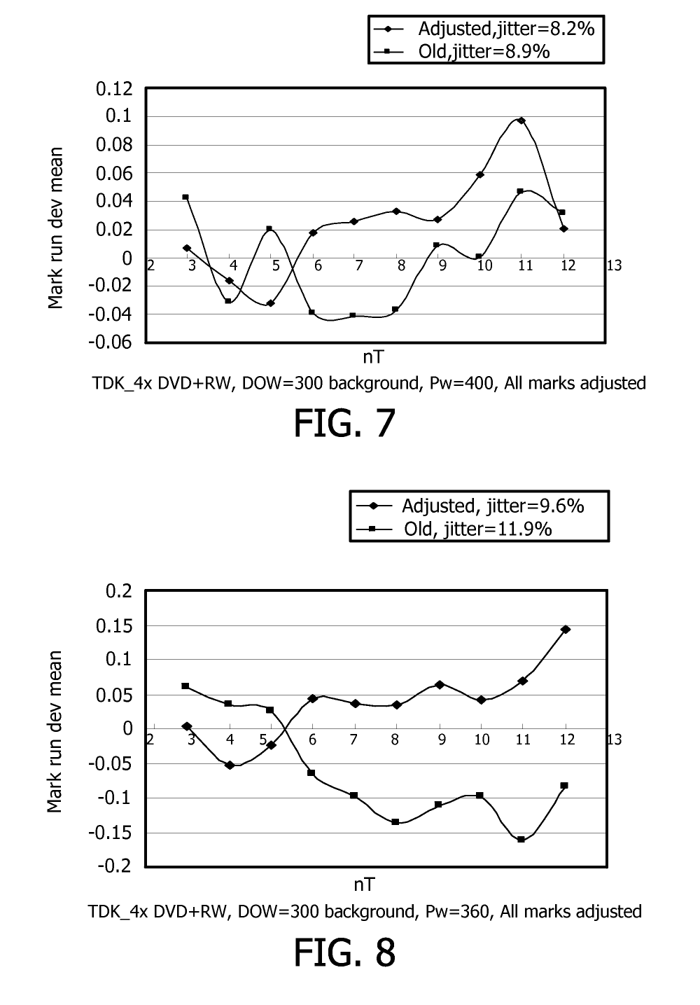

FIG. 7 is a diagram shown the comparison of the adjusted mark runlength deviations with the original ones. This experiment is carried out on a TDK_{—}4xDVD+RW disc with a speed of 2.4× under the situations in which background DOW=300 and Pw (power)=400 mW. From FIG. 7, it can be seen that the jitter is changed from 8.9% to 8.2% after adjustment. The jitter decreases and the quality of writing is improved.

FIG. 8 shows the result which is produced by the experiment of writing on a TDK_{—}4xDVD+RW disc under the situation in which DOW=300 and Pw (power)=360 mW. Here, a low writing power is used (Pw=360) to check the robustness of the method in accordance with the present invention, because a lower power is preferred for DOW cycleability and a low power will result in more writing noise then more challenge to signal measurement. From FIG. 8, it can be seen that the jitter is changed from 11.9% to 9.6% after adjustment. The jitter decreases and the quality of writing is improved.

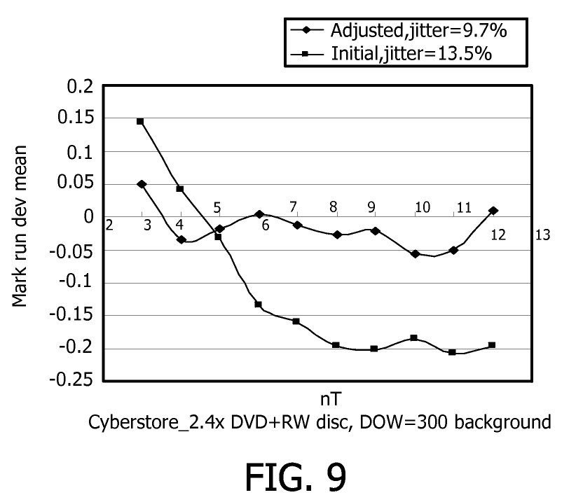

FIG. 9 shows the result which is produced by the experiment of writing on another kind of disc, a Cyberstore_{—}2.4xDVD+RW disc, under the situation in which DOW=300 and Pw (power)=370 mW. From FIG. 9, it can be seen that the jitter is changed from 13.5% to 9.7% after adjustment. The jitter decreases and the quality of writing is improved. This experiment further proves that the method according to the present invention has good robustness.

The above embodiments as described are only illustrative, and not intended to limit the technique approaches of the present invention. Although the present invention is described in details referring to the preferable embodiments, those skilled in the art will understand that the technique approaches of the present invention can be modified or equally displaced without departing from the spirit and scope of the technique approaches of the present invention, which will also fall into the protective scope of the claims of the present invention.

1. A method of adjusting parameters for writing an optical disc, said method comprising the steps of:
testing a region to be written in a re-writeable optical disc without changing writing power level,
calculating writing parameters in the region to be written based on the tested result,
adjusting writing parameters based on the calculated result.

2. A method as claimed in claim 1, wherein said step of testing further comprises the step of measuring and determining signal quality of a written region.

3. A method as claimed in claim 1, wherein the tested result is physical properties of the re-writable optical disc with different direct over write histories.

4. A method as claimed in claim 1, wherein the writing parameters are timing parameters.

5. The method as claimed in claim 1, wherein the calculated result is calculated by a predetermined mark runlength variation and writing parameters' gain.

6. An optical disc writer, comprising:
a reading and writing device for reading or writing data on an optical disc,
a measurement device coupled to the reading and writing device for measuring and determining signal quality of a written region,
a calculation device coupled to the reading and writing device and the measurement device for calculating writing parameters in a region to be written based on tested result made in the region to be written without changing writing power level,
an adjustment device coupled to the reading and writing device for adjusting writing parameters based on the calculated result.

7. An optical disc writer as claimed in claim 6, wherein the tested result is physical properties of the re-writable optical disc with different direct over write histories.

8. An optical disc writer as claimed in claim 6, wherein the writing parameters are timing parameters.

9. An optical disc writer as claimed in claim 6, wherein the calculated result is calculated by a predetermined mark runlength variation and writing parameters' gain.

10. A method of writing data on a re-writeable optical disc, said method comprising the steps of:
writing data on the re-writeable optical disc,
stopping to write data and determining signal quality of the written data,
testing a region to be written in a re-writeable optical disc without changing writing power level,
calculating writing parameters in the region to be written based on the tested result,
adjusting writing parameters based on the calculated result,
continuing to write data on the re-writeable optical disc.

11. A method as claimed in claim 10, wherein the tested result is physical properties of the re-writable optical disc with different direct over write histories.

12. A method as claimed in claim 10, wherein the writing parameters are timing parameters.

13. A method as claimed in claim 10, wherein the calculated result is calculated by a predetermined mark runlength variation and writing parameters' gain.
